(19) United States
(12) Patent Application Publication
(10) Pub. No.: US 2007/0250874 A1
(43) Pub. Date: Oct. 25, 2007

(54) System and method of indexing video content

(75) Inventor: Jerald Robert Howcroft, Beverly Hills, MI (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/387,555

(22) Filed: Mar. 23, 2006

(51) Int. Cl. H04N 7/173; H04N 7/16

(52) U.S. Cl. 725/89; 725/88; 725/134; 725/142

(57) ABSTRACT

A system and method of indexing video content is disclosed. In a particular embodiment, the method includes receiving a set index command at a set-top box device during transmission of video content from the set-top box device to a display device coupled to the set-top box device. The method also includes storing an index marker at a position in the video content, where the set-top box device transmits the video content to the display device beginning at the position in response to a selection of the index marker.

### FIELD OF THE DISCLOSURE

The present disclosure is generally related to indexing video content.

### BACKGROUND

Television service providers offer a variety of movie and television programming. Advances in cable, satellite, and other technologies allow television service providers to offer their customers hundreds of channels. Users can often select from multiple channels that show similar content, such as educational content, sports content, news content, or movie content. The volume of potential programs and channels can make viewing all desired programs impracticable. Thus, users often record programs using digital video recorders and other storage devices.

Users often prefer to manipulate video content during recording or playback. For example, users may wish to begin playback at a certain scene or other position in the video content. Additionally, users may wish to delete or otherwise edit portions of the video content and only save portions they wish to view repeatedly. Nonetheless, conventional controls, such as rewinding, forwarding, and recording over unwanted portions can be inefficient and can yield poor results. Hence, there is a need for an improved system and method of indexing video content.

### BRIEF DESCRIPTION OF THE DRAWINGS

FIG. 1 is a block diagram illustrating a particular embodiment of a system to index video content;

FIG. 2 is a block diagram illustrating a second particular embodiment of a system to index video content;

FIG. 3 is a flow diagram illustrating a particular embodiment of a method of indexing video content;

FIG. 4 is a diagram illustrating a particular embodiment of a graphical user interface (GUI) to index video content;

FIG. 5 is a diagram illustrating a second particular embodiment of a graphical user interface (GUI) to index video content;

FIG. 6 is a diagram illustrating a third particular embodiment of a graphical user interface (GUI) to index video content;

FIG. 7 is a diagram illustrating a fourth particular embodiment of a graphical user interface (GUI) to index video content; and

FIG. 8 is a diagram of an illustrative embodiment of a general computer system.

### DETAILED DESCRIPTION OF THE DRAWINGS

A system to index video content is disclosed and includes a set-top box device having a processor and a memory device accessible to the processor. The memory device includes an index module executable by the processor to receive a set index command at a set-top box device during transmission of video content from the set-top box device to a display device coupled to the set-top box device. The index module is executable by the processor to store an index marker at a position in the video content. The set-top box device transmits the video content to the display device beginning at the position after a selection of the index marker is received.

In another embodiment, a method of indexing video content is disclosed and includes receiving a set index command at a set-top box device during transmission of video content from the set-top box device to a display device coupled to the set-top box device. The method also includes storing an index marker at a position in the video content, where the set-top box device transmits the video content to the display device beginning at the position in response to a selection of the index marker.

In another embodiment, a computer program embedded in a computer-readable medium is disclosed and includes instructions to receive a set index command at a set-top box device during transmission of video content from the set-top box device to a display device coupled to the set-top box device. The computer program also includes instructions to store an index marker at a position in the video content, where the set-top box device transmits the video content to the display device beginning at the position in response to a selection of the index marker.

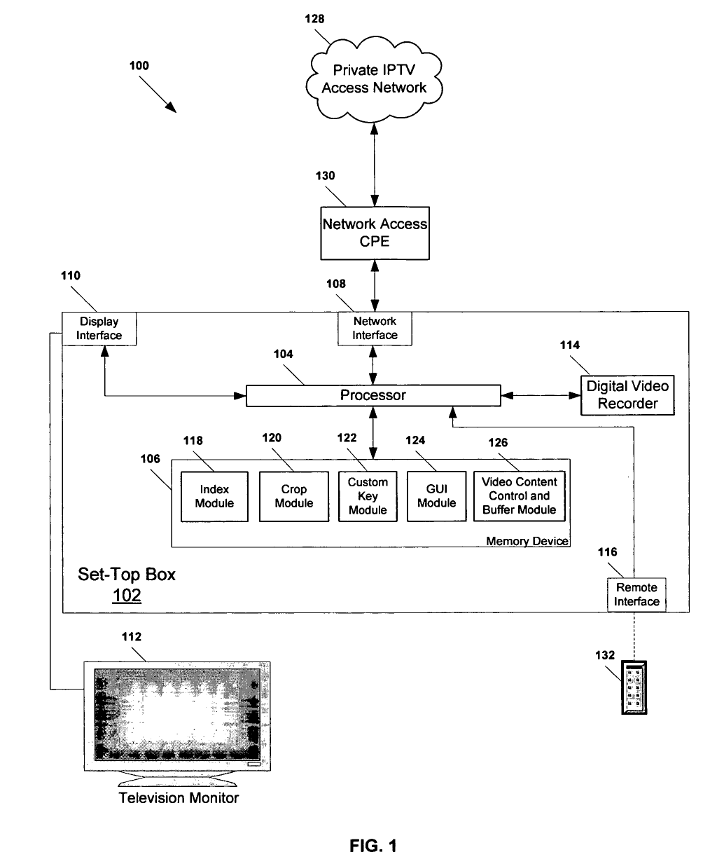

Referring to FIG. 1, an embodiment of a system to index video content is illustrated and designated generally at 100. The system includes a set-top box 102 that contains a processor 104 and a memory device 106 that is accessible to the processor 104. The processor 104 communicates with a network interface 108. Further, the processor 104 communicates with a display interface 110, such as a television interface, through which the set-top box device 102 can communicate video content, prompts, graphical user interfaces, or other content to an external display device, such as a television monitor 112. The processor 104 can communicate with an internal video storage device, such as a digital video recorder (DVR) 114. In addition, the processor 104 can communicate with a remote control device 132, via a remote control interface 116.

In an illustrative, non-limiting embodiment, the processor 104 can communicate with an external access network, such as an Internet Protocol Television (IPTV) access network 128, via the network interface 108. In a particular embodiment, network access customer premises equipment (CPE) 130 can facilitate communication between the network interface 108 and the IPTV access network 128. The network access CPE 130 can include a router, a local area network device, a modem, such as a digital subscriber line (DSL) modem, any other suitable device for facilitating communication between the network interface 108 of the set-top box device 102 and the IPTV access network 128, or any combination thereof.

The set-top box device can receive a request from a user to view video content. The video content can be retrieved from the DVR 114. Alternatively, the video content can be requested and received by the set-top box device 102 from the IPTV access network 128 and recorded at the DVR 114. Further, the set-top box device 102 can transmit the video content to the television monitor 112. In a particular embodiment, the memory device 106 can include an index module 118 that is executable by the processor 104 to communicate with the remote control device 132 to receive a set index input selection from a user during transmission of the video content to the television monitor 112. The index module 118 can be executable by the processor 104 to store an index marker at a position in the video content, such as a scene, a frame, a time, or any combination thereof. In an illustrative embodiment, the index module 118 can be executable by the processor 104 to communicate with the remote control device 132 to receive a find index input selection and to start transmitting the video content to the television monitor 112 at a position at which an index is stored.

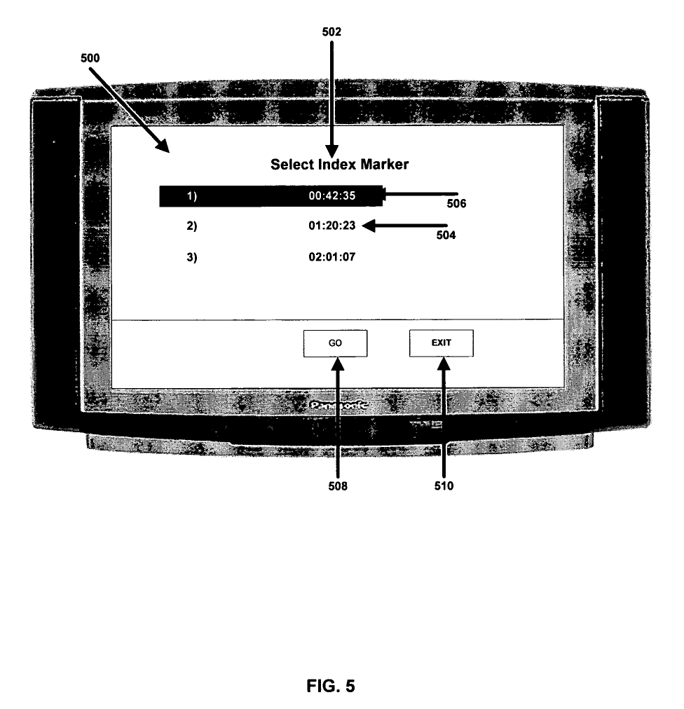

In an illustrative embodiment, if the set-top box 102 receives an input to find an index marker in video content that contains more than one index marker, the index module 118 can be executable by the processor 104 to instruct a graphical user interface (GUI) module 124 to transmit a GUI or other prompt to the television monitor 112 presenting the user with a list of selectable positions in the video content where index markers are stored. A selection of a position from the list can be received at the set-top box 102, and the set-top box 102 can transmit the video content to the television monitor 112 beginning at the selected position. An example of a GUI to select positions where index markers are stored is illustrated in FIG. 5.

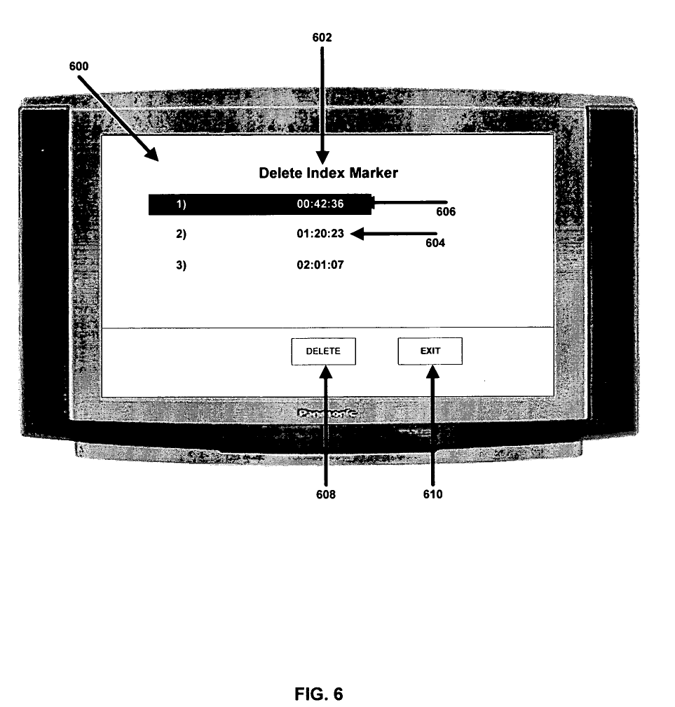

In another particular embodiment, the index module 118 can be executable by the processor 104 to delete an index marker from the video content in response to a delete index input selection received via the remote control device 132. In an illustrative embodiment, the index module 118 can be executable by the processor 104 to delete an index marker stored at a position in the video content within a certain time of the delete command. Alternatively, if the set-top box 102 receives an input to delete an index marker in video content that contains more than one index marker, the index module 118 can be executable by the processor 104 to instruct a graphical user interface (GUI) module 124 to transmit a GUI or other prompt to the television monitor 112 presenting the user with a list of selectable positions in the video content where index markers are stored. A selection of a position from the list can be received at the set-top box 102, and the set-top box 102 can delete an index marker stored at the selected position. An example of a GUI to select index markers to delete is illustrated in FIG. 6.

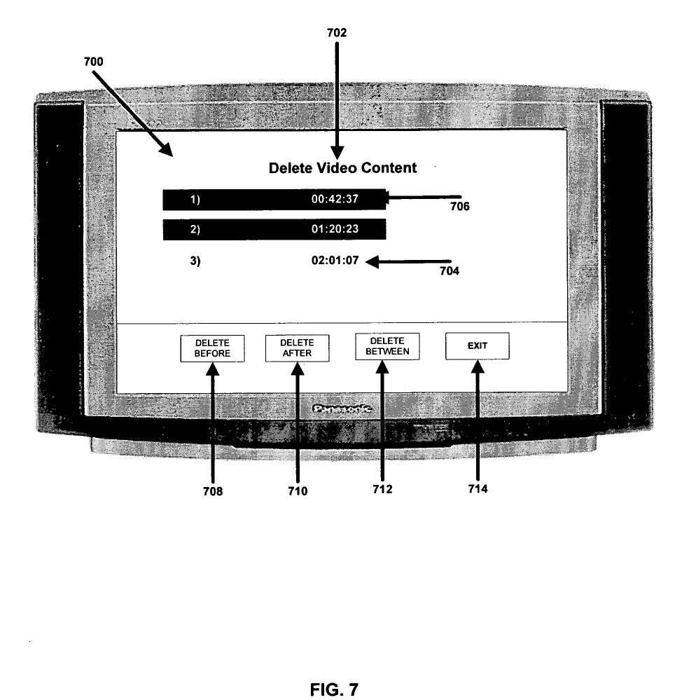

In a particular embodiment, the memory device 106 can also include a crop module 120 executable by the processor 104 to delete a portion of video content between two index markers, before an index marker, after an index marker, or any combination thereof. For example, the crop module 120 can be executable by the processor 104 to communicate with the remote control device 132 to receive an input to delete video content. The crop module 120 can be executable by the processor 104 to instruct the GUI module 124 to transmit a GUI to the television monitor 112 presenting the user with positions at which index markers are stored and with options to delete video content before, after or between selected index markers. The set-top box 102 can receive user selections from the GUI and the crop module 124 can be executable by the processor 104 to delete portions of the video content. An example of a GUI to delete portions of video content is illustrated in FIG. 7.

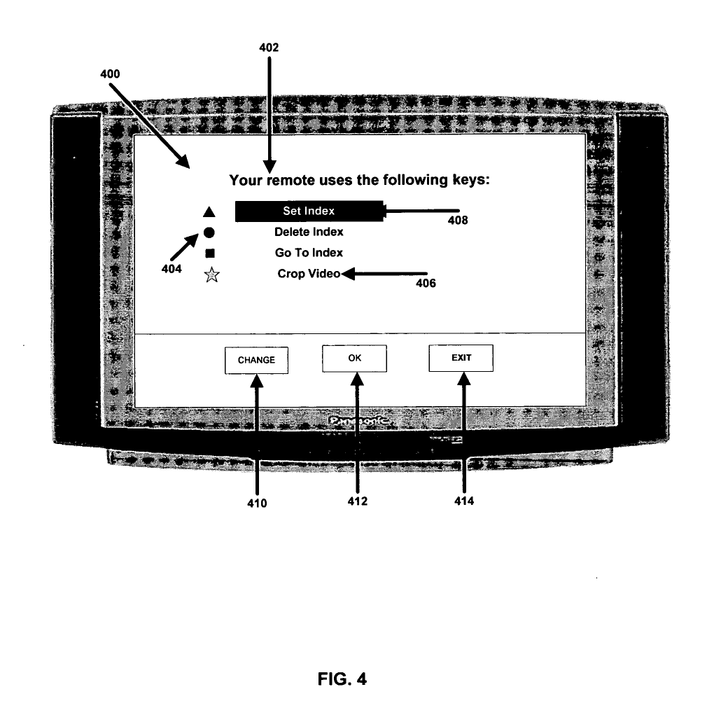

In an illustrative embodiment, the remote control device 132 can include a plurality of smart buttons that are programmable to issue customized commands to the set-top box 102. The smart buttons can be programmed to issue commands determined by a manufacturer or service provider. Alternatively, the memory device 106 can include a custom key module 122 that is executable by the processor 104 to communicate with the remote control device 132 to receive a change key function command. In an illustrative embodiment, the custom key module 122 can be executable by the processor to instruct the GUI module 124 to transmit a GUI to the television monitor 112 presenting the user with a list of smart button assignments and options to change commands assigned to each smart button. An example of a GUI to assign commands to smart buttons is illustrated in FIG. 4.

The memory device 106 can also include a video content control and buffer module 126 that is executable by the processor 104 to receive video content requested by a user and to buffer the video content before transmitting it to the display interface 110, in order to prevent underflow.

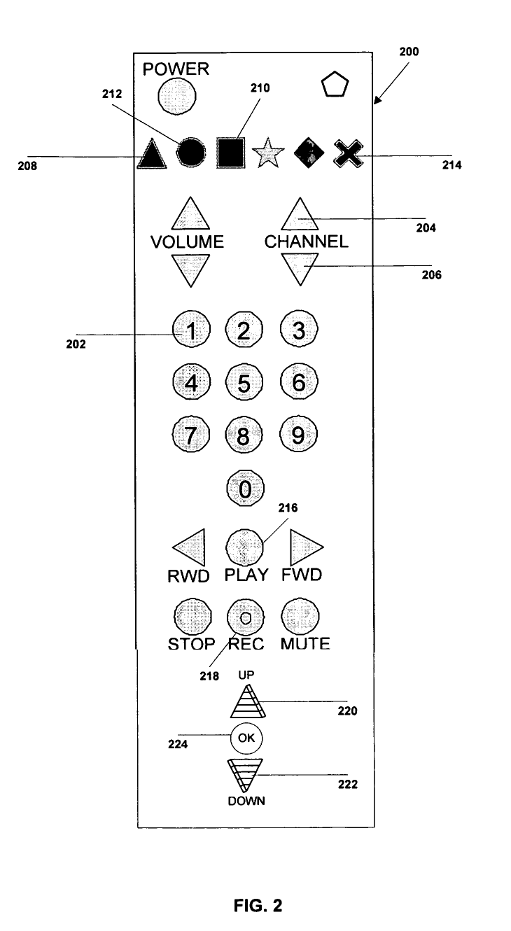

Referring to FIG. 2, a particular embodiment of a remote control device configured to index video content is illustrated and designated generally at 200. The remote control device 200 includes a keypad having at least one numeric key 202. The remote control device 200 can also include sequential channel change keys, such as a channel up key 204 and a channel down key 206. The remote control device 200 can also include an ‘UP’ button 220, a ‘DOWN’ button 222, and an ‘OK’ button 224.

Further, the remote control device 200 can include one or more custom keys, such as the keys 208-214, which can be programmed by the user, a service provider, or any combination thereof, to communicate particular commands. For example, the remote control 200 can include a set index key 208 that a user can press to store an index marker at a position in video content. In a particular embodiment, the remote control 200 can include a find index key 210 that a user can press to return to a position at which an index marker is stored in the video content. In addition, the remote control 200 can also include a delete index marker key 212 that a user can press to delete an index marker that is stored in video content. In another embodiment, the remote control 200 can include a crop key 214 that a user can press to delete a portion of the video content before an index marker, after an index marker, or between two index markers.

In an illustrative embodiment, a user can issue a request to view video content to a set-top box device using the remote control device 200. For example, the user can press the ‘PLAY’ key 216 to request video content stored in a DVR of the set-top box device. Alternatively, the user can request the video content from an Internet Protocol Television (IPTV) network or other network by pressing the channel up key 204 or channel down key 206. The user can record the video content at the DVR by pressing the ‘RECORD’ key 218. The set-top box device can transmit the video content to a display device coupled to the set-top box device. In a particular embodiment, the user can issue a set index input by selecting the set index key 210 during transmission of the video content to the display device. The set-top box device can store an index marker at a position in the video content, such as a scene, a frame, a time, or any combination thereof, in response to a set index input selection.

In another particular embodiment, the user can issue a find index marker input by selecting the find index key 210 on the remote control device 200. The set-top box can find an index marker stored at a position in the video content and transmit the video content starting at the position where the index marker is stored. In an illustrative embodiment, if index markers are stored at more than one position in the video content, the set-top box device can transmit a GUI or other prompt to the display device presenting the user with a list of selectable positions in the video content where index markers are stored. The user can select a position from the list using, for example, the ‘UP’ button 220, the ‘DOWN’ button 222, the ‘OK’ button 224, or any combination thereof. An example of a GUI to select positions where index markers are stored is illustrated in FIG. 5.

In another particular embodiment, the user can issue a delete index marker input by selecting the delete index key 212 on the remote control device 200. The set-top box device can delete an index marker stored at a position in the video content within a certain time of the delete command. In an illustrative embodiment, if index markers are stored at more than one position in the video content, the set-top box device can transmit a GUI or other prompt to the display device presenting the user with a list of selectable positions in the video content where index markers are stored. The user can select a position from the list using, for example, the ‘UP’ button 220, the ‘DOWN’ button 222, the ‘OK’ button 224, or any combination thereof. An example of a GUI to delete index markers is illustrated in FIG. 6.

In a particular embodiment, the user can issue a crop input by selecting the crop key 214 on the remote control device 200. The set-top box device can delete video content before an index marker stored at a position in the video content; after an index marker stored at a position in the video content; or between two index markers in the video content. In an illustrative embodiment, the set-top box device can transmit a GUI or other prompt to the display device presenting the user with a list of selectable positions in the video content where index markers are stored. Further, the GUI or other prompt can also include choices of video content to delete in relation to one or more selected index markers. The user can make selections from the GUI or other prompt using, for example, the ‘UP’ button 220, the ‘DOWN’ button 222, the ‘OK’ button 224, or any combination thereof. An example of a GUI to delete portions of video content is illustrated in FIG. 7.

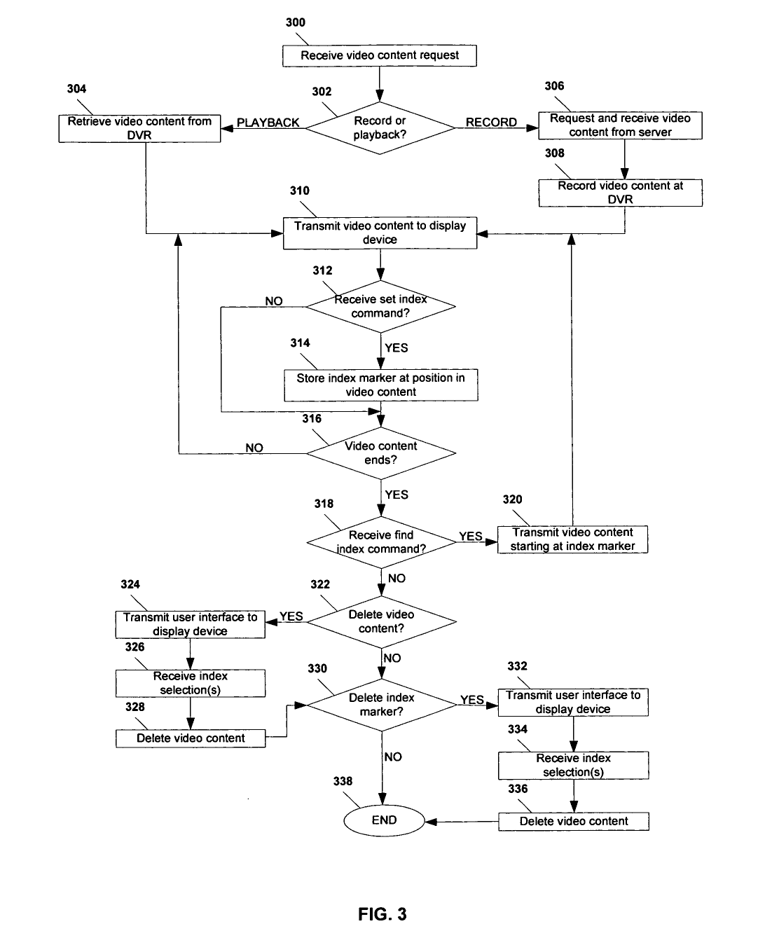

Referring to FIG. 3, a particular embodiment of a method of providing selectable video content is illustrated. At block 300, a set-top box device receives a video content request from a user. In an illustrative embodiment, the set-top box device can receive the video content request via a keypad of the set-top box device or from a remote control device communicating with the set-top box device. Moving to decision step 302, the set-top box device determines whether the video content is stored at the set-top box device or is to be recorded at the set-top box device, for example, at a digital video recorder (DVR). If the set-top box device determines that the video content is stored and is to be played back, the method proceeds to block 304, and the set-top box device retrieves the requested video content from the DVR or other memory device. The method then advances to block 310.

Returning to decision step 302, if the set-top box device determines that the video content is to be recorded at the set-top box device, the method moves to block 306. At block 306, in a particular embodiment, the set-top box can request and receive the video content from a server of an Internet Protocol Television (IPTV) network, cable network, satellite network, or other network. The method then proceeds to block 308, and the set-top box device can begin recording the video content at the DVR or other memory device. The method continues to block 310.

At block 310, the set-top box device transmits the requested video content to a display device coupled to the set-top box device. The method moves to decision step 312, and the set-top box device determines whether it has received a set index command, for example, from a remote control device communicating with the set-top box device. If the set-top box device determines that a set index command has not been received, the method advances to decision step 316. Conversely, if the set-top box determines that a set index command has been received, the method continues to block 314, and the set-top box device stores an index marker at a position in the video content at which the index command is received. The method then proceeds to decision step 316.

At decision step 316, the set-top box determines whether the video content has ended. If the video content has not ended, the method returns to block 310, and the set-top box device continues transmitting the requested video content to the display device. Conversely, in a particular embodiment, if the set-top box determines that the video content has ended, the method can continue to decision step 318, and the set-top box device can determine whether it has received a command to find an index marker stored in the video content. If the set-top box determines that a find index command has been received, the method continues to block 320, and the set-top box device transmits the video content to the display device starting at the index marker. The method then returns to block 310. Returning to decision step 318, if the set-top box does not receive a find index command, the method advances to decision step 322.

In a particular embodiment, at decision step 322, the set-top box device can determine whether it has received a command to delete a portion of the video content. If the set-top box determines that it has not received a command to delete a portion of the video content, the method proceeds to decision step 330. On the other hand, if the set-top box determines that it has received a command to delete a portion of the video content, the method proceeds to block 324, and the set-top box device transmits a user interface to the display device. In an illustrative embodiment, the user interface can include index markers stored at positions of the video content and selectable options to delete video before, after, or between index markers. Continuing to block 326, the set-top box device receives selections of one or more index markers and video content to delete. The set-top box device deletes the selected video content at block 328. The method then advances to decision step 330.

At decision step 330, the set-top box determines whether it has received a command to delete an index marker stored at a position of the video content. If the set-top box determines that it has not received a command to delete an index marker stored at a position of the video content, the method terminates at 338. On the other hand, if the set-top box determines that it has received a command to delete an index marker, the method proceeds to block 332, and the set-top box device transmits a user interface to the display device. In an illustrative embodiment, the user interface can include index markers stored at positions of the video content. Continuing to block 334, the set-top box device receives selections of one or more index markers. The set-top box device deletes the selected index markers at block 336. The method then terminates at 338.

Though the aspects of the disclosed method has been presented in a certain order, for ease of description, certain portions of the method may be performed in a different order or simultaneously. For example, commands to find index markers, delete index markers, to delete video content, or any combination thereof, can be received prior to the end of requested video content. Further, determining whether such commands are received at the set-top box device can be performed in any sequence.

Referring to FIG. 4, an illustrative embodiment of a graphical user interface (GUI) to program one or more smart keys of a remote control device to index video content is illustrated and designated generally at 400. The GUI 400 includes an indication 402 of various commands or inputs issued when smart keys of the remote control device are selected. The GUI 400 can also include shapes 404 or other designators corresponding to the smart keys. In addition, the GUI 400 can include a current command 406 assigned to each of the designated smart keys. The user can select a smart key shape 404, command 406, or any combination thereof, for example by using arrow keys on the remote control device to manipulate a highlight bar 408 and by selecting an ‘OK’ or similar button on the remote control device.

In an illustrative, non-limiting embodiment, the GUI 400 can also include a first selectable indicator 410 of an option to change a command 406 assigned to a smart key. For example, if the user selects the ‘Set Index’ command, the user can then select the ‘CHANGE’ indicator 410 and select a different command to assign to a triangular smart key, such as the smart key 208 illustrated in FIG. 2. The GUI 400 can also include a second selectable indicator 412 of an option to approve the commands 406 that are assigned to each smart key. In addition, the GUI 400 can also include a third selectable indicator 414 of an option to exit the GUI 400 and return to another screen or to programming.

Referring to FIG. 5, a particular embodiment of a graphical user interface (GUI) to find index markers in video content is illustrated and designated generally at 500. The GUI 500 can include a list of multiple index markers that are stored at positions of video content. In an illustrative embodiment, the GUI 500 can include an indication 502 that a user can choose an index marker to find. The GUI 500 can also include indicators of positions in the video content where index markers are stored, such as times 504. The user can select from the available index marker positions, for example, by using arrow keys on a keypad to manipulate a highlight bar 506 and by pressing a ‘SELECT’ key, ‘OK’ key, or similar key when a desired index marker position 504 is highlighted. In a particular embodiment, the GUI 500 can also include a ‘GO’ indicator 508 that a user can select to request that the video content be transmitted starting at the position of a selected index marker. Further, the GUI 500 can include an ‘EXIT’ indicator 510 that a user can select to exit the GUI 500, return to a previous GUI, return to programming, or any combination thereof.

Referring to FIG. 6, a particular embodiment of a graphical user interface (GUI) to index video content by deleting index markers is illustrated and designated generally at 600. The GUI 600 can include a list of multiple index markers that are stored at positions of video content. In an illustrative embodiment, the GUI 600 can include an indication 602 that a user can choose index markers to delete. The GUI 600 can also include indicators of positions in the video content where index markers are stored, such as times 604. The user can select from the available index marker positions, for example, by using arrow keys on a keypad to manipulate a highlight bar 606 and by pressing a ‘SELECT’ key, ‘OK’ key, or similar key when a desired index marker position 604 is highlighted. In a particular embodiment, the GUI 600 can also include a ‘DELETE’ indicator 608 that a user can select to delete a selected index marker. Further, the GUI 600 can include an ‘EXIT’ indicator 610 that a user can select to exit the GUI 600, return to a previous GUI, return to programming, or any combination thereof.

Referring to FIG. 7, a particular embodiment of a graphical user interface (GUI) to index video content by deleting video content in relation to index markers is illustrated and designated generally at 700. The GUI 700 can include a list of multiple index markers that are stored at positions of video content. In an illustrative embodiment, the GUI 700 can include an indication 702 that a user can choose video content to delete. The GUI 700 can also include indicators of positions in the video content where index markers are stored, such as times 704. The user can select from the available index marker positions, for example, by using arrow keys on a keypad to manipulate a highlight bar 706 and by pressing a ‘SELECT’ key, ‘OK’ key, or similar key when a desired index marker position 704 is highlighted. In a particular embodiment, a user can select multiple index marker positions 704.

Further, the GUI 700 can include a ‘DELETE BEFORE’ indicator 708 that a user can select to delete video content before a position of a selected index marker back to the previous index marker or start of the video content, whichever comes first. In addition, the GUI 700 can include a ‘DELETE AFTER’ indicator 710 that a user can select to delete video content after a position of a selected index marker to a next index marker of the end of the video content, whichever comes first. In an illustrative embodiment, the GUI 700 can include a ‘DELETE BETWEEN’ indicator 712 that a user can select to delete video content between two selected index markers. The GUI 700 can also include an ‘EXIT’ indicator 714 that a user can select to exit the GUI 700, return to a previous GUI, return to programming, or any combination thereof.

In conjunction with the configuration of structure described herein, the system and method disclosed provide indexing and cropping of video content by allowing users of set-top box devices to set their own tags or indexes in video content. In an illustrative embodiment, the user can select a set index input, for example, on a remote control communicating with a set-top box device. The set-top box device can store an index marker at a position in the video content at which the set index input selection was received. Further, the user can select a find index input on the remote control device to skip ahead or back to such indexes when viewing the video content. In another particular embodiment, the user can select a crop input to delete one or more portions of the video content that are before an index marker, after an index marker, or between two index markers.

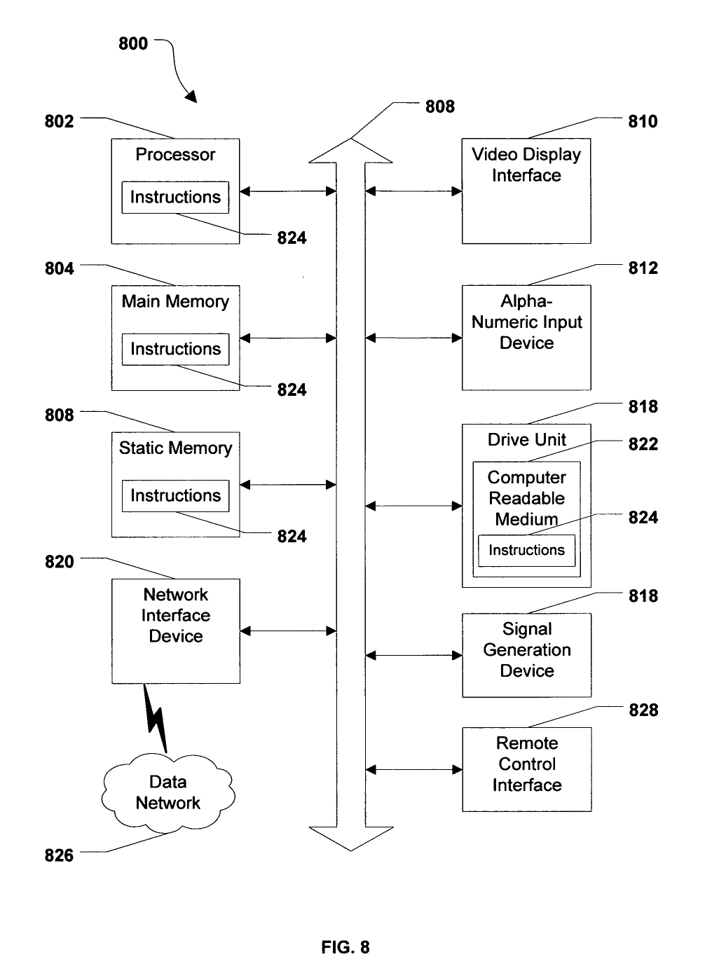

Referring to FIG. 8, an illustrative embodiment of a general computer system is shown and is designated 800. The computer system 800 can include a set of instructions that can be executed to cause the computer system 800, or a portion thereof, to perform any one or more of the methods or computer based functions disclosed herein. The computer system 800, or any portion thereof, may operate as a standalone device or may be a hardware or software module within a server or other device.

The computer system 800 can also be implemented as or incorporated into various other devices, such as the set-top box device illustrated in FIG. 1, or any other machine capable of executing a set of instructions (sequential or otherwise) that specify actions to be taken by that machine. In a particular embodiment, the computer system 800 can be implemented using electronic devices that provide audio, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a remote control input, an input control panel, a keyboard, a mouse, a gaming station input, or one or more keys disposed on a set-top box device. The computer system 800 can also include a disk drive unit 816, or other secondary storage interface configured to receive a removable secondary storage medium. The computer can also include a signal generation device 818, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives instructions 824 responsive to a propagated signal, so that a device connected to a network 826 can communicate audio, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of indexing video content, the method comprising:
receiving a set index command at a set-top box device during transmission of video content from the set-top box device to a display device coupled to the set-top box device; and
storing an index marker at a position in the video content, wherein the set-top box device transmits the video content to the display device beginning at the position in response to a selection of the index marker.

2. The method of claim 1, wherein the set index command is received from a remote control device communicating with the set-top box device.

3. The method of claim 1, wherein the set index command is received from a programmable smart key of the remote control device.

4. The method of claim 1, further comprising receiving a record command and storing the video content at a digital video recorder (DVR) of the set-top box device.

5. The method of claim 1, further comprising receiving a playback command and retrieving the video content from a digital video recorder (DVR).

6. The method of claim 1, wherein the position is a frame of the video content.

7. The method of claim 1, wherein the position is a time position of the video content.

8. The method of claim 7, further comprising:
receiving a selection to delete an index marker at the set-top box device; and
removing the index marker from the video content.

9. The method of claim 1, further comprising:
receiving a first selection of a first index marker and a second selection of a second index marker;
receiving a delete content command; and
deleting a portion of the video content, wherein the deleted portion begins at the first index marker and ends at the second index marker.

10. The method of claim 1, further comprising:
receiving a first selection of a first index marker and a second selection of a second index marker;
receiving a delete content command; and
deleting all but a portion of the video content, wherein the undeleted portion begins at the first index marker and ends at the second index marker.

11. A set-top box, comprising:
a processor and a memory device accessible to the processor;
wherein the memory device includes an index module executable by the processor to receive a set index command at a set-top box device during transmission of video content from the set-top box device to a display device coupled to the set-top box device;
wherein the index module is executable by the processor to store an index marker at a position in the video content; and
wherein the set-top box device transmits the video content to the display device beginning at the position after a selection of the index marker is received.

12. The set-top box of claim 11, wherein the set index command is received from a keypad of the set-top box device.

13. The set-top box of claim 11, wherein the set index command is received from a programmable smart key of a remote control device communicating with the set-top box device.

14. The set-top box of claim 11, further comprising a digital video recorder (DVR) to store the video content.

15. The set-top box of claim 11, wherein the index module is executable by the processor to remove an index marker from the video content in response to a delete index marker command.

16. The set-top box of claim 11, further comprising a crop module executable by the processor to delete a portion of the video content, wherein the portion begins at a first selected index marker and ends at a second selected index marker.

17. The set-top box of claim 11, further comprising a crop module executable by the processor to delete all but a portion of the video content, wherein the portion begins at a first selected index marker and ends at a second selected index marker.

18. A computer program embedded in a computer-readable medium, the computer program comprising:
instructions to receive a set index command at a set-top box device during transmission of video content from the set-top box device to a display device coupled to the set-top box device; and
instructions to store an index marker at a position in the video content, wherein the set-top box device transmits the video content to the display device beginning at the position in response to a selection of the index marker.

19. The computer program of claim 18, further comprising instructions to remove an index marker from the video content in response to a delete index marker command.

20. The computer program of claim 18, further comprising instructions to delete a portion of the video content, wherein the portion begins at a first selected index marker and ends at a second selected index marker.

21. The computer program of claim 18, further comprising instructions to delete all but a portion of the video content, wherein the portion begins at a first selected index marker and ends at a second selected index marker.

22. The computer program of claim 18, further comprising instructions to delete all but a portion of the video content, wherein the portion begins at the start of the video content and ends at a selected index marker.

23. The computer program of claim 18, further comprising instructions to delete all but a portion of the video content, wherein the portion begins at a first selected index marker and ends at the end of the video content.
